(19) United States
(12) Patent Application Publication
(10) Pub. No.: US 2009/0259669 A1
(43) Pub. Date: Oct. 15, 2009

(54) METHOD AND SYSTEM FOR ANALYZING TEST DATA FOR A COMPUTER APPLICATION

(75) Inventors: Kristin A. Abbruzzi, Riverside, RI (US); Thomas C. Hickman, Hollis, NH (US)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: Iron Mountain Incorporated

(21) Appl. No.: 12/100,962

(22) Filed: Apr. 10, 2008

(51) Int. Cl. G06F 7/00

(52) U.S. Cl. 707/100; 707/E17.009

(57) ABSTRACT

Methods and systems are provided for analyzing assets. According to one implementation, a method is provided that comprises extracting the digital content units from a group of digital data, assigning substitute IDs to the extracted digital content units, and determining statistical characteristics of the substitute IDs to determine statistical characteristics of the group of digital data.

### DESCRIPTION OF THE INVENTION

I. Technical Field

The present invention generally relates to the field of data generation and statistical model production systems.

II. Background Information

Electronic data processing system developers along with technical support crew run tests through systems to find out ways to improve system performance and respond to defects or software enhancements. For testing applications, it is ideal to have actual data, for example, actual transactional data from customers, in order to see how the system is performing under real life conditions. This then helps with understanding the software and seeing what aspects of the data may be causing problems within the system.

Customers occasionally allow access to data to a group of product developers or technical support specialists in order to perform the tests. This granting of access then allows the group to take the original raw customer data, and replicate or identify system problems that may exist. Furthermore, the group can then analyze the processed data results to determine what aspects of the customer data affect the performance of the software application. For example, some developers may analyze customer data to consider how characteristics of the data such as size or format may affect the system in terms of performance, features, etc. They may monitor the effects of the data characteristic variance on system behavior, and ultimately make respective configurations, enhancements, and added features, that will improve the overall system. The traditional approach is to use some sort of logging mechanism to store data (usually in an error situation).

However, product developer and technical support groups are often limited in their access to actual customer data due to compliance and privacy requirements. Even when the customer data is available, distribution may be limited so that, unless the customer provides special permissions, the confidential data may not be useable in a test environment and thus, is unable to be analyzed. The advent of numerous compliance requirements, coupled with a number of highly publicized news stories detailing corporate mishandling of sensitive customer data, presents a heightened need to take critical steps towards further protecting customer data.

Presently, it is difficult to create a testing environment in which security issues are minimized when one is running customer sensitive data through a system to perform tests. The customer might choose to “clean” the confidential or sensitive information from the customer sensitive data before providing it to a product engineering group, if providing at all. Yet, while cleaning up data effectively helps the customer to protect its data, the effort may be time-consuming or resource-consuming. Further, the cleaned up data may not perform the same as the uncleaned data in the tests, thus limiting the ability of system developers and technical support crew to identify and respond to defects or software enhancements.

### SUMMARY

To address many of the above-mentioned problems, a generation and analysis technique has been designed that allow users to generate and analyze test data for a computer application. Methods and systems are disclosed for processing groups of customer data to develop test data. Each group of customer data includes digital content units.

In one embodiment consistent with principles of the invention, a method is provided for analyzing test data for a computer application for processing groups of digital data having digital content units. The method comprises extracting the digital content units from a group of digital data; assigning substitute IDs to the extracted digital content units; and determining statistical characteristics of the substitute IDs to determine statistical characteristics of the group of digital data.

In one embodiment, the extracted digital content units may be words or they may be phrases, and assigning substitute IDs to extracted word digital content units may be handled separately from assigning substitute IDs to extracted phrase digital content units. In another embodiment, the extracted digital content units may have numerical content and assigning the substitute IDs further comprises converting the numerical content into non-numerical content.

In one embodiment, the method of assigning substitute IDs to the extracted digital content units comprises creating a record for a selected extracted digital content unit. A substitute ID may be generated for the selected extracted digital content unit which is then associated with the record. As the extracted digital content units have at least one type, the substitute ID may be prefixed with a signature for identifying a type associated with the selected extracted digital content unit.

In another embodiment, a collection of records that has been developed for extracted digital content units is checked for the existence of the selected extracted digital content. If the selected extracted digital content unit does not already exist in the collection, a substitute ID may be assigned to the selected extracted digital content unit and a count of occurrences of the selected extracted digital unit may be initiated. If the selected extracted digital content unit already exists in the collection, then the substitute ID associated therewith is extracted and the count of the occurrences of the selected extracted digital content units is incremented.

In a further embodiment, the record, the substitute ID associated with the selected extracted digital content unit for which the record was developed, and the count of occurrences of the selected extracted digital content unit may be stored in a storage system. When assigning the substitute IDs to the extracted digital content units has been completed for the group of digital data, the record may be deleted from the storage system.

One method to determine the statistical characteristics of the group of digital data is calculating low, mean, and high values of frequency of occurrences of the substitute IDs corresponding to the extracted digital content units. Once the statistical characteristics of the group of digital data are determined, a visual representation of these statistical characteristics may be developed. One embodiment has the visual representation having at least a first parameter and a second parameter, the second parameter being different from the first parameter. To develop the visual representation, the statistical characteristics corresponding to the first and second parameters may be retrieved and plotted against each other.

Consistent with other disclosed embodiments, a computer-readable medium is provided that stores program instructions for implementing any of the above-described methods.

In a further embodiment of the invention, a system for analyzing test data for a computer application that is processing groups of digital data having digital content units has a data store; a data extractor for extracting the digital content units from a group of digital data; an ID assigning unit for assigning substitute IDs to the extracted digital content units; and a statistical unit for determining statistical characteristics of the substitute IDs to determine statistical characteristics of the group of digital data.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this specification, illustrate one (several) embodiment(s) of the invention and together with the description, serve to explain the principles of the invention. In the drawings:

FIG. 1 illustrates an exemplary computer system 10 for analyzing test data for a computer application, consistent with an embodiment of the invention;

FIG. 2 is a block diagram of an exemplary software architecture for the data analyzer 100 of FIG. 1;

FIG. 3 is a block diagram of an exemplary software architecture for the storage system 120 of FIG. 1;

FIG. 4 is a block diagram of an exemplary software architecture for the data store 110 of FIG. 1;

FIG. 5 is an example of a flow diagram for a routine for identifying and extracting source data within a set of emails, consistent with an embodiment of the invention;

FIG. 6 is an example of a flow diagram showing further detail of the block 520 of FIG. 5 for profiling the digital content units;

FIG. 7 is an example of a flow diagram showing further detail of the block 601 of FIG. 6 for associating the substitute ID with the group of digital data;

FIG. 8 is an example of a flow diagram showing further detail of the block 540 of FIG. 5 for developing a visual representation of the group of digital data; and

FIG. 9 is a block diagram of an exemplary software architecture for the asset analyzer 210 of FIG. 2.

### DETAILED DESCRIPTION

Reference will now be made in detail to the present embodiment (exemplary embodiment) of the invention, an example of which is illustrated in the accompanying drawings. Wherever possible, the same reference numbers will be used throughout the drawings to refer to the same or like parts. While several exemplary embodiments are described herein, modifications, adaptations and other implementations are possible, without departing from the spirit and scope of the invention. For example, substitutions, additions or modifications may be made to the components illustrated in the drawings, and the exemplary methods described herein may be modified by substituting, reordering, or adding steps to the disclosed methods. Accordingly, the following detailed description does not limit the invention. Instead, the proper scope of the invention is defined by the appended claims.

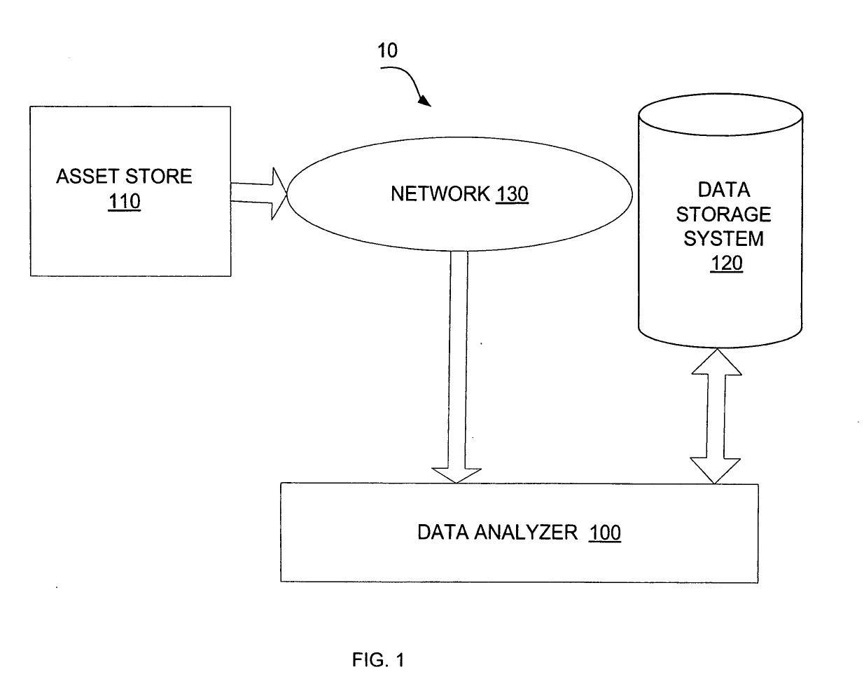

FIG. 1 illustrates an exemplary computer system 10 for analyzing data within a set of individual assets, in accordance with one or more disclosed embodiments. In particular, the system 10 may provide functionality for analysis of emails and attachments thereto, with one goal being the detection of trends and/or specific patterns of emails within a customer database. However, it is to be understood that the system is not to be limited to the analysis of emails and attachments thereto, nor is the goal limited to trend or pattern detection. The systems and methods of the present invention are also applicable to analyzing other types of data, such as measurement data or categorical data and for other goals, such as measuring complexity, size and dimension.

In this exemplary embodiment, data analyzer system 10 has a data store 110 (also known as an asset store 110), a data analyzer 100 (also known as an asset analyzer 100) and a storage system 120. Data store 110 is connected to data analyzer 100 through a network 130. Network 130 may be a shared, public, or private network, may encompass a wide area or local area, and may be implemented through any suitable combination of wired and/or wireless communication networks. Furthermore, network 130 may comprise an intranet, the Internet, or an extranet.

One of skill in the art will appreciate that although one data store is depicted in FIG. 1, any number of these entities may be provided. Furthermore, one of ordinary skill in the art will recognize that functions provided by one or more entities of data analyzer system 10 may be combined. Data store 110 may be one or more memory or storage devices that store data as well as software. Data store 110 may also comprise one or more of RAM, ROM, magnetic storage, or optical storage, for example.

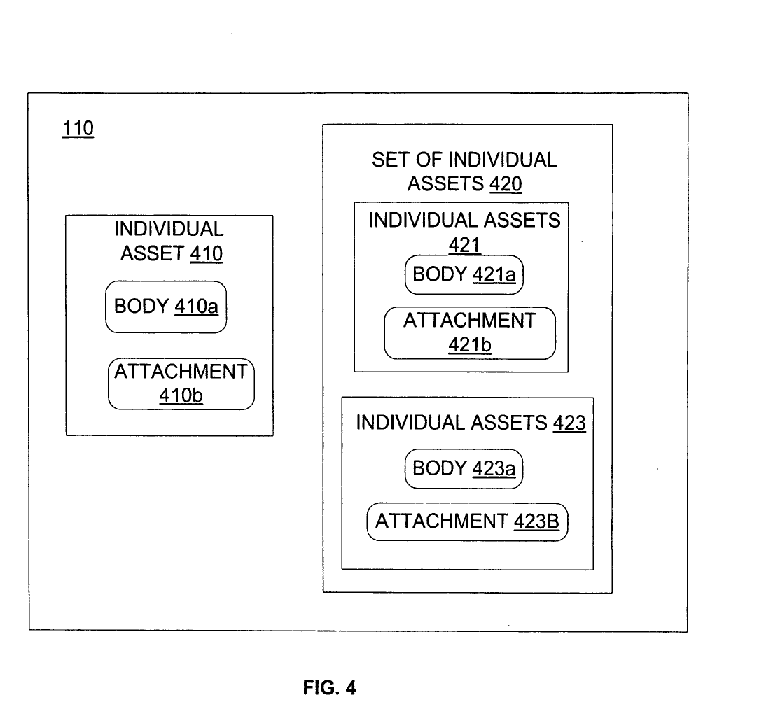

FIG. 4 is a block diagram of an exemplary software architecture for data store 110, in which may be stored groups of digital data having digital content units. Data store 110 may have stored therein digital data such as an individual asset 410, for example an email, which may have a body 410a and, optionally, one or more attachments 410b. Further, data store 110 may also have stored therein digital data such as a set of individual assets 420, for example a group of emails, which may also have a body and attachment. For example, the set 420 may have an individual asset 421, which may have a body 421a and, optionally, one or more attachments 421b, and an individual asset 423, which may have a body 423a and, optionally, one or more attachments 423b.

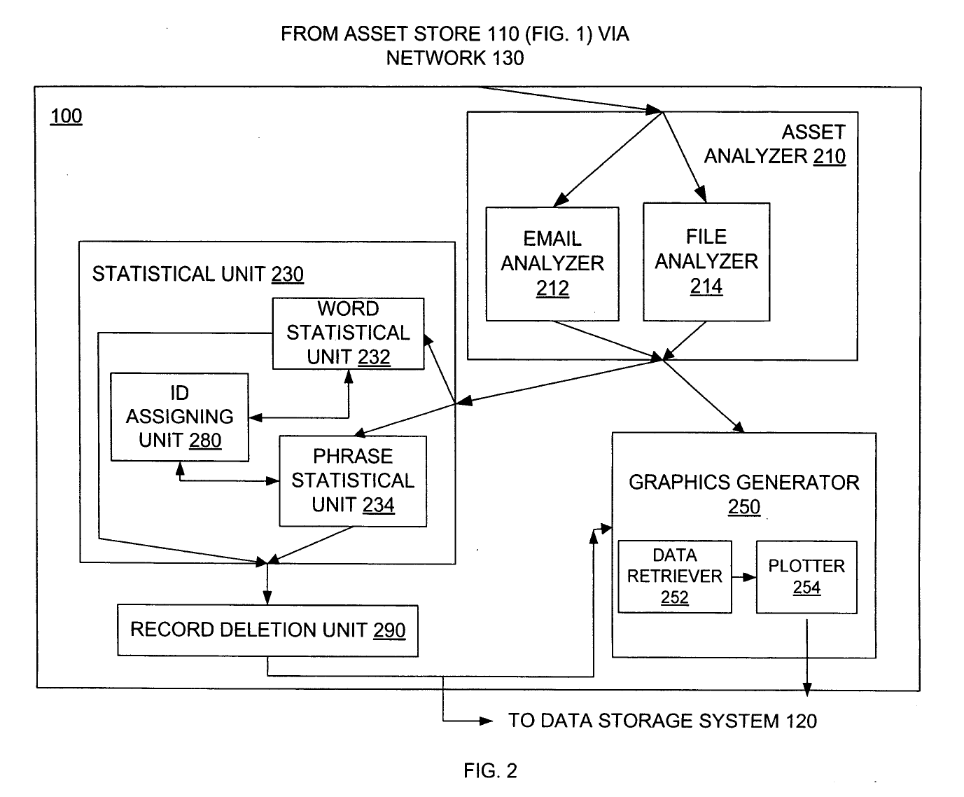

Data storage system 120 (FIG. 1) may be one or more memory or storage devices that store data as well as software. Data storage system 120 may also comprise one or more of RAM, ROM, magnetic storage, or optical storage, for example. Data storage system 120 may store program modules that perform one or more processes for identifying and extracting source data within a set of individual assets. Program modules that provide for identifying and extracting source data within a set of individual assets are discussed in more detail in connection with FIG. 2.

FIG. 2 illustrates an exemplary software architecture for data analyzer 100 of FIG. 1. Data analyzer 100 may comprise a general purpose computer (e.g., a personal computer, network computer, server, or mainframe computer) having one or more processors (not shown in FIG. 1) that may be selectively activated or reconfigured by a computer program. The data analyzer 100 may also be implemented in a distributed network. For example, the data analyzer 100 may communicate via network 130 with one or more additional data analyzers (not shown) for operation on different sets of data.

Data analyzer 100 has an asset analyzer 210, a statistical unit 230, and a graphics generator 250, for use in analyzing an email body and attachments in an email corpus, recording characteristics of emails, and providing the capability to produce graphical representations for the data for further analysis.

Asset analyzer 210 has an email analyzer 212 and a file analyzer 214 for analyzing an email corpus and gathering statistical information from it such as email sizes, character sets, encoding, attachment information, etc. Email analyzer 212 accepts a path to data store 110 where emails may be stored in RFC 822 format. These emails have text body and attachments. Email analyzer 212 takes individual emails from data store 110 as an input and extracts information such as message ID, sent date, MIME type, char set, encoding style, formatting, header information, email size and email body text, that are used by statistical unit 230 for further analysis. The raw data extracted while analyzing an email corpus are inserted into data storage system 120 by email analyzer 212 for computing Word and Phrase occurrences.

Email Analyzer 212 scans through the path selected by the end user to identify individual emails in each directory and/or sub-directory one level at a time. For each email, email headers are parsed and header values are stored in a Business Object class “Emailmst”. Email body text is extracted and saved in a separate Business Object Class “Emailbody”. Business Objects hold intermediate values retrieved while parsing emails and attachments. “Emailmst” will hold email headers. “Emailbody” will hold email body text. “Attachmentmst” will hold attachment attributes. “Attachmenttext” will hold attachment text. “Attachmentcontentdetails” will hold content details (text, image or text and image)

Attachments are extracted and saved in pre-defined folders separately in data storage system 120. Each attachment is analyzed on parameters such as type of attachment, size, content type and encoding by file analyzer 214. This information is stored in data storage system 120 for further analysis such as developing comparisons or generating graphical representations.

File Analyzer 214 analyzes certain characteristics of all accompanying attachments of emails. These characteristics are recorded in data storage system 120. For each attachment, an instance of File Analyzer class is created. File Analyzer 214 retrieves file attributes and holds these values in a Business Object Class “Attachmentmst”. “Attachmentmst” will hold attachment attributes. “Attachmenttext” will hold attachment text. “Attachmentcontentdetails” will hold content details (text, image or text and image).

File Analyzer 214 extracts text information from the file (for attachments of type—.doc, .rtf, .xml, .html, .htm, .xls, .txt, .dat, .log, .ppt, .pdf) and holds the text in a Business Object Class AttachmentText. For attachments of known types such as—.doc, .rtf, .xml, .html, .htm, .xls, .txt, .dat, log, .ppt, .pdf—it determines attachment content details and the values are stored in a Business Object Class AttachmentContentdetails.

Statistical unit 230 is a statistical unit that is responsible for determining statistical characteristics of the substitute IDs. By determining the statistical characteristics of the substitute IDs, it is possible to determine statistical characteristics of a group of digital data without reference to the digital data and therefore without reference to the confidential information in the digital data. The statistical unit 230 has two calculator components: word statistical unit 232 and phrase statistical unit 234, with which it determines statistical characteristics of the data such as calculating low, mean, and high values of frequency of occurrences of the unique substitute IDs corresponding to the extracted digital content units. Statistical unit 230 also has an ID assigning unit 280 for assigning unique substitute IDs to the extracted digital content units.

As noted above, the extracted digital content units have at least one type; and at least one of the extracted digital content units comprises a word or a phrase, the phrase having more than one word. Word statistical unit 232 (also known as email statistical unit 232) is responsible for determining the number of words in an email body and its accompanying attachment within a group of emails, and, in conjunction with ID assigning unit 280, mapping the same words to a substitute ID. Word statistical unit 232 is also responsible for calculating the frequency of each mapped word by calculating the frequency of each substitute ID in the email body and its attachment. Frequency calculation values are stored in data storage system 120 for further analysis using a WordFrequencyCalculator class, which identifies unique words within email body and attachment text along with the occurrence of each word in an email and its attachment, respectively.

Phrase statistical unit 234 (also known as file statistical unit 234) is responsible for determining the number of phrases such as word pairs in each email body and its accompanying attachment within a group of emails and, in conjunction with ID assigning unit 280, mapping the same phrases to a substitute ID. Phrase statistical unit 234 is also responsible for calculating frequency of each mapped phrase by calculating the frequency of each substitute ID in the email body and its attachment. Frequency calculation values are stored in data storage system 120 for further analysis using a PhraseFrequencyCalculator class to identify unique phrases from email body and attachment text along with the occurrence of each phrase in an email and its attachment, respectively.

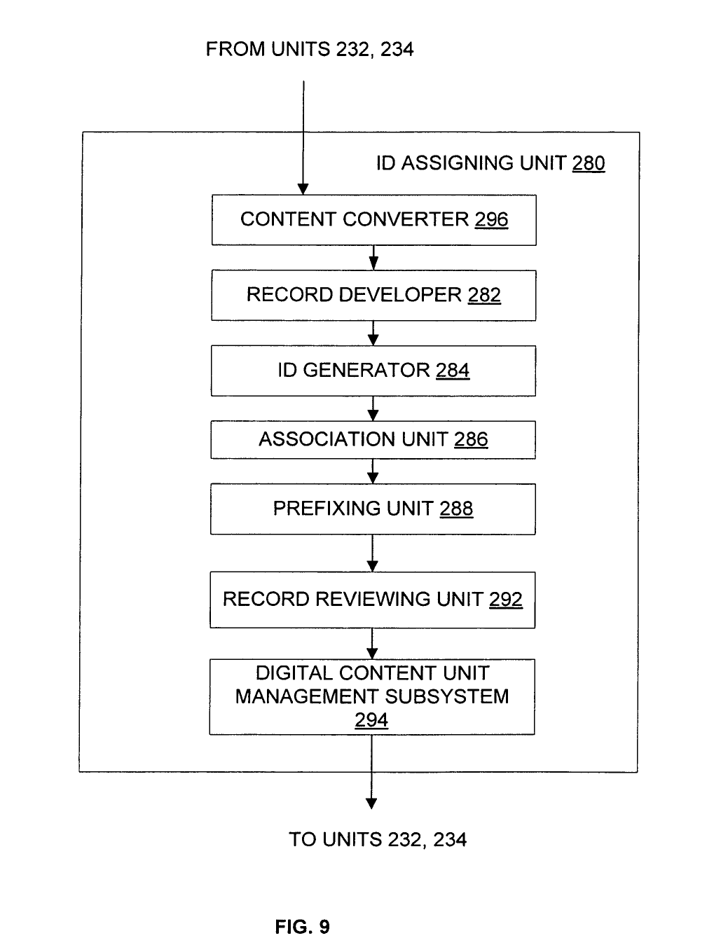

FIG. 9 shows the architecture of the ID assigning unit 280, which is responsible for assigning unique substitute IDs to the extracted digital content units, in greater detail. The ID assigning unit 280 has a record developer 282 for developing a record for a selected extracted digital content unit, and an ID generator 284 for generating a substitute ID for the selected extracted digital content unit. The ID assigning unit 280 also has an association unit 286 for associating the substitute ID with the record; and a prefixing unit 288 for prefixing the substitute ID with a signature identifying a type associated with the selected extracted digital content unit.

The ID assigning unit 280 also has a record reviewing subsystem (or unit) 292 for checking a collection of records developed for the extracted digital content units for the existence of the selected extracted digital content unit. It further has a digital content unit management subsystem 294, which is responsible, once the record reviewing subsystem (or unit) 292 checks for the existence of the selected extracted digital content unit, for ensuring that each extracted digital content unit is associated with a substitute ID and a count of its frequency of occurrence in the group of digital data under investigation.

If the selected extracted digital content unit does not already exist in the collection of records, the digital content unit management subsystem 294 is responsible for assigning the substitute ID to the selected extracted digital content unit and initiating a count of occurrences of the selected extracted digital content unit. If the selected extracted digital content unit already exists in the records, the digital content unit management subsystem 294 is responsible for extracting the substitute ID associated therewith and incrementing the count of the occurrences of the selected extracted digital content unit.

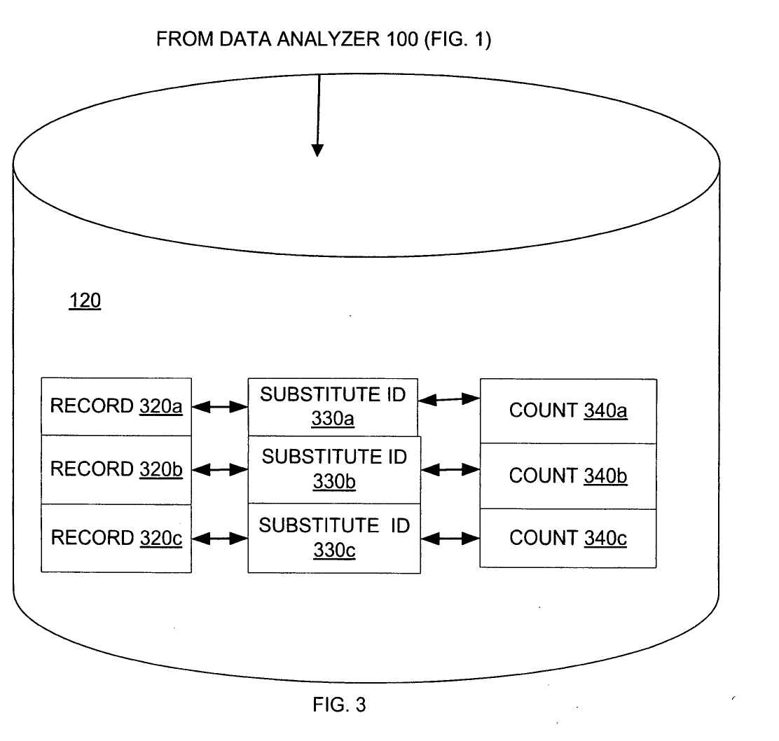

The data storage system 120 (FIG. 1) is responsible for storing the output of the statistical unit 230, namely the record, the substitute ID associated with the selected extracted digital content unit for which the record was developed, and the count of occurrences of the selected extracted digital content unit. FIG. 3 is a block diagram of an exemplary software architecture for data storage system 120 of FIG. 1. As shown in FIG. 3, each record 320a, 320b, 320c is stored with its associated mapping ID 330a, 330b, and 330c, respectively, and its frequency count value 340a, 340b, and 340c, respectively.

The graphics generator 250 (FIG. 2) is responsible for developing a visual representation of the statistical characteristics of the group of digital data. The visual representation may have at least a first parameter and a second parameter, the second parameter being different from the first parameter. The graphics generator 250 refers to the data in data storage system 120 in order to plot histograms for various parameters. For example, in order to plot a histogram for a parameter say, “Email Size”, Graphics generator 250 connects to data storage system 120 and uses data retriever 252 to query and retrieve the size of each email. It then plots the histogram with frequency of emails on the Y-axis and email size on the X-axis using plotter 254.

Upon completing the above tasks successfully, statistical log entries are made and the next email is processed, the records are deleted from data storage system 120, but the substitute ID and statistical information such as the frequency occurrence values are saved. In that way, company-specific and other confidential data will be eliminated from the text of emails and other documents, but the data developed from the email and documents may be preserved for future analysis.

After processing emails from all the folders and/or subfolders, control is passed to the record deletion unit 290, which is responsible for deleting the records from data storage system 120 when analysis has been completed for the group of digital data and the unique substitute IDs have been assigned to all of the extracted digital content units for the group of digital data. The record deletion unit 290 ensures that records 320a, 320b, 320c (FIG. 3) are deleted in the data storage system 120, but that their associated substitute IDs 330a, 330b, and 330c, and their respective frequency count values 340a, 340b, and 340c, remain stored.

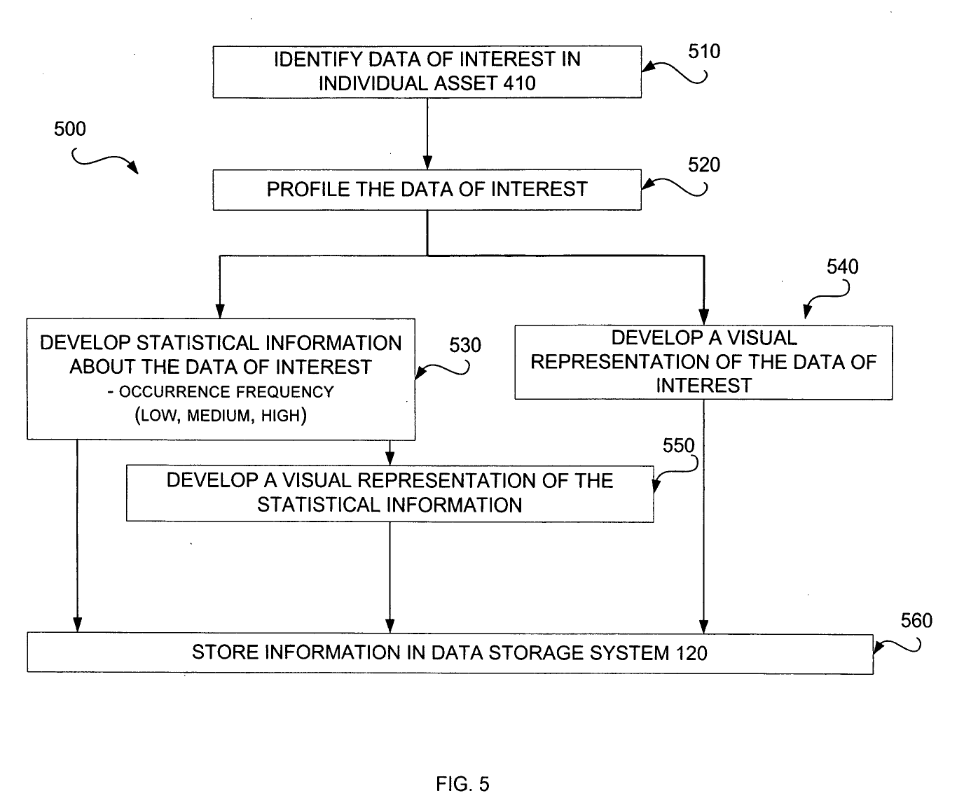

FIG. 5 is an example of a flow diagram of a routine 500 for implementing a method for identifying and extracting source data within a set of emails, consistent with an embodiment of the invention. The routine 500 starts with a block 510 to identify data of interest (also known as digital content units) in an individual asset 410 (FIG. 4) that are in a group of data that may have been retrieved from asset store 110. The data of interest, such as words and phrases, are extracted in the manner above described from data such as emails and attachments using the asset analyzer 210 (FIG. 2).

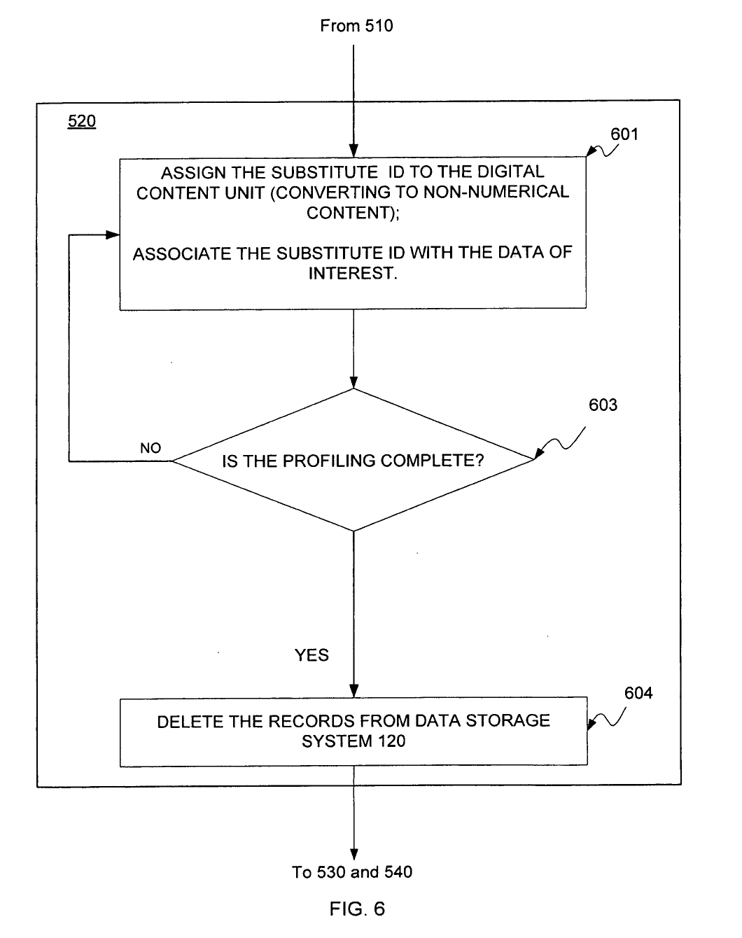

The routine 500 may then proceed to a block 520 for profiling the data of interest. FIG. 6 is an example of a flow diagram showing further detail of the block 520 of FIG. 5 for profiling the data of interest. One method for profiling the data of interest starts with a block 601, in which substitute IDs, also known as mapping IDs, are assigned to the digital content unit, which, as described above, may be a word or a phrase. If the digital content unit has numerical content, the content may be converted by block 601 into non-numerical content using content converter 296. Block 601 may also cause the substitute IDs to be associated with the data of interest.

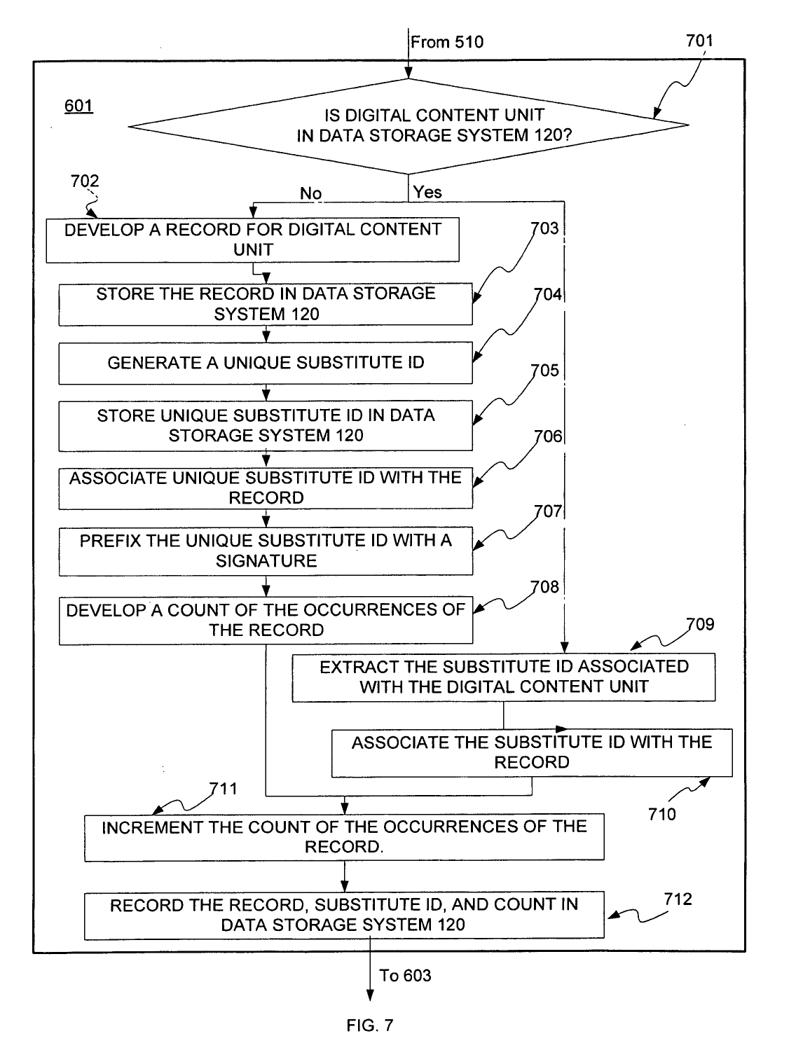

FIG. 7 is an example of a flow diagram showing further detail of block 601 of FIG. 6 for assigning the substitute ID to digital content units and associating the substitute ID with the data of interest. Block 601 starts with a block 701 for checking a collection of records developed for the extracted digital content units for the existence of the selected extracted digital content unit.

If, at block 701, it is determined that a record in the data storage system 120 is not already associated with the extracted digital content unit, block 601 proceeds to block 702 for developing a record for a selected extracted digital content unit. Block 601 may then proceed to a block 703 for storing the record in the collection of records in the data storage system 120. Block 601 may then proceed to block 704 for generating a substitute ID for the selected extracted digital content unit. Block 601 may then proceed to block 705 for storing the substitute ID in the data storage system 120. Block 601 may then proceed to block 706 for associating the substitute ID with the record for the selected extracted digital content unit. Block 601 may then proceed to block 707 for prefixing the substitute ID with a signature for identifying a type associated with the selected extracted digital content unit. Block 601 may then proceed to block 708 for developing a count of the occurrences of the record within the group of data under investigation. Block 601 may then proceed to block 711, described below.

If, at block 701, it is determined that a record in data storage system 120 is already associated with the extracted digital content unit, block 601 proceeds to block 709 for extracting the substitute ID associated with the extracted digital content unit currently under review from the record in data storage system 120. Block 601 then proceeds to block 710 for ensuring that the substitute ID is associated with the record currently under investigation.

In one embodiment, the collection of records is organized into a WordMst table. As an example of the above, when the extracted data of interest are words, after parsing an email body for words, each unique word is checked for its existence in the WordMst table. If the word already exists, then its MappingId is extracted. If the word does not exist, then a new MappingId is generated. The new word is inserted into the WordMst table. Each unique word, its occurrence and MappingId will be maintained in a Business Object. This Business Object will then be inserted into an EmailWordDtls table or AttachmentPhraseDtls table as appropriate, using a DAO class.

As another example, when the extracted digital content units are phrases, after parsing the email body for phrases, each unique phrase is checked for its existence in a PhraseMst table. If the phrase already exists, then its MappingId is extracted. If the phrase does not exist, then a new MappingId is generated. The new phrase is inserted in to the PhraseMst table. Each unique Phrase, its occurrences and MappingId—is maintained in a Business Object. This Business Object is then inserted into the EmailPhraseDtls table or AttachmentPhraseDtls table as appropriate, using a DAO class.

Block 601 may then proceed to block 711 for incrementing the count of the occurrences of the record, using the word statistical unit 232 or the phrase statistical unit 234 as appropriate. Incrementing of the count occurs whether a record has been newly created for the extracted digital content unit or a record in data storage system 120 was found to be already associated with the extracted digital content unit. After the incrementing, block 601 proceeds to block 712 for storing the record, substitute ID, and count in data storage unit 120. In one embodiment, these values (unique phrase, occurrence) are maintained in memory using a HashMapCollection Class.

The storing task of block 701 signals the completion of profiling for the digital content unit, and block 601 ends. Block 520 proceeds to block 603, where it is determined whether or not the entire group of data under investigation has been profiled. If not, block 520 proceeds to block 601 again to process another digital content unit. If the profiling has been completed for the group of data under investigation, block 520 proceeds to block 604, where record deletion unit 290 is used to delete the records from data storage system 120. The data of interest for the entire group of data are now profiled and ready for statistical analysis and display. Returning to FIG. 5, the routine 500 may exit block 520 and proceed to block 530 for developing statistical information about the newly profiled data of interest. Such statistics may include among other analyses analyzing the occurrence frequencies of the counts developed in block 520 and in data storage systems 120. After exiting block 530, the routine 500 may proceed to a block 560 to store the newly developed statistical information in the data storage system 120. Before doing so, it may proceed to block 550 for developing a visual representation of the statistical information.

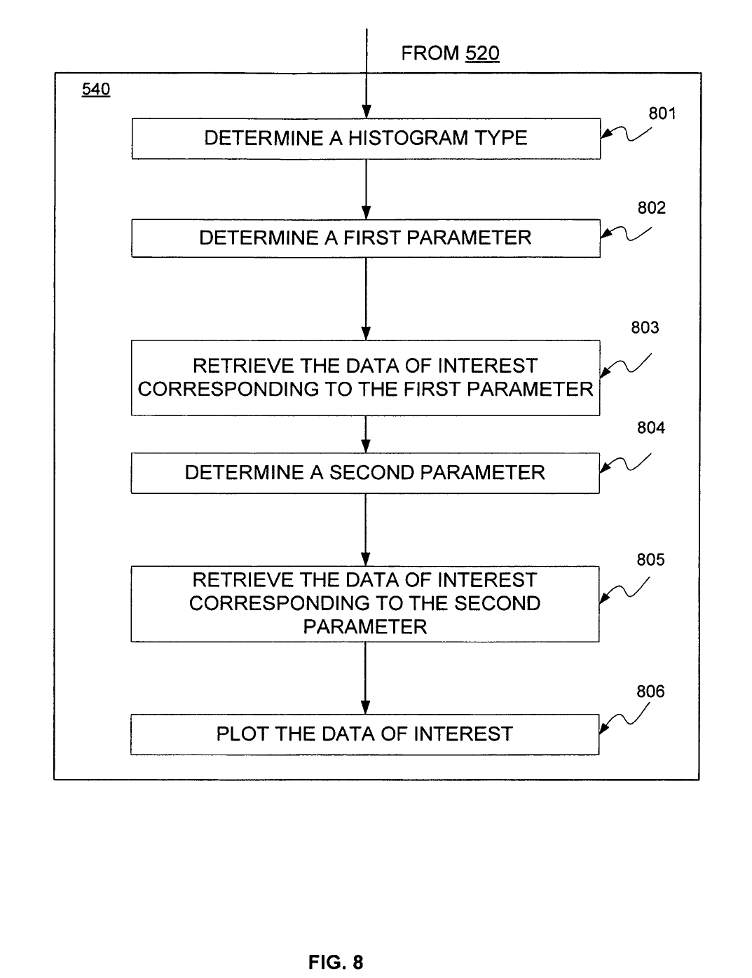

After exiting block 520, the routine 500 may also proceed to block 540 for developing a visual representation of the data on interest. FIG. 8 is an example of a flow diagram showing further detail of block 540 of FIG. 5 for developing visual representations. Block 540 starts with block 801 for determining a desired histogram type, and may then proceed to block 802 for determining a first parameter, and then to block 803 for retrieving the data of interest corresponding to the first parameter. As an example, if a selected parameter was “MimeType”, the number of emails may be counted for each “MimeType” in the “EmailMst” table. Block 540 may then proceed to block 804 for determining a second parameter that is different from the first parameter and to block 805 for retrieving the data of interest corresponding to the second parameter. As examples of the retrievals, the system may use an “EmailHistogram” class to refer to the “EmailMst” table to extract values of the selected email header for all the emails within the corpus. These values may be used to plot histograms that will help analyze the traits of emails within an email corpus. The system may also use an “AttachmentHistogram” class to refer to the “AttachmentMst” table to extract values of the selected attribute of Attachments. These values may be used to plot histograms that will help analyze the traits of attachments within an email corpus.

Block 540 may then proceed to block 806 for plotting the data of interest. As an example, the system could us a “WordPhraseFrequencyPlotter” class to refer to the “EmailWordDtls”, “EmailPhraseDtls”, “AttachmentWordDtis”, “AttachmentPhraseDtls” tables to extract occurrences of Words and Phrases in Emails and Attachments respectively. These occurrences may be used (after some computation) to plot histograms that help analyze the traits of words, phrases being used within emails and/or attachments.

After exiting block 540 (FIG. 5), the routine 500 may proceed to block 560 to store the information developed from the development of the visual representation in data storage system 120. After exiting block 560, the routine 500 then ends.

Although the software modules have been described above as being separate modules, one of ordinary skill in the art will recognize that functionalities provided by one or more modules may be combined. As one of ordinary skill in the art will appreciate, one or more of modules may be optional and may be omitted from implementations in certain embodiments.

The foregoing description has been presented for purposes of illustration. It is not exhaustive and does not limit the invention to the precise forms or embodiments disclosed. Modifications and adaptations of the invention will be apparent to those skilled in the art from consideration of the specification and practice of the disclosed embodiments of the invention. For example, the described implementations include software, but systems and methods consistent with the present invention may be implemented as a combination of hardware and software or in hardware alone. Examples of hardware include computing or processing systems, including personal computers, servers, laptops, mainframes, micro-processors and the like. Additionally, although aspects of the invention are described for being stored in memory, one skilled in the art will appreciate that these aspects can also be stored on other types of computer-readable media, such as secondary storage devices, for example, hard disks, floppy disks, or CD-ROM, the Internet or other propagation medium, or other forms of RAM or ROM.

Computer programs based on the written description and methods of this invention are within the skill of an experienced developer. The various programs or program modules can be created using any of the techniques known to one skilled in the art or can be designed in connection with existing software. For example, program sections or program modules can be designed in or by means of Java, C++, HTML, XML, or HTML with included Java applets. One or more of such software sections or modules can be integrated into a computer system or existing e-mail or browser software.

Moreover, while illustrative embodiments of the invention have been described herein, the scope of the invention includes any and all embodiments having equivalent elements, modifications, omissions, combinations (e.g., of aspects across various embodiments), adaptations and/or alterations as will be appreciated by those in the art based on the present disclosure. The limitations in the claims are to be interpreted broadly based on the language employed in the claims and not limited to examples described in the present specification or during the prosecution of the application, which examples are to be construed as non-exclusive. Further, the blocks of the disclosed routines may be modified in any manner, including by reordering blocks and/or inserting or deleting blocks, without departing from the principles of the invention. It is intended, therefore, that the specification and examples be considered as exemplary only, with a true scope and spirit of the invention being indicated by the following claims and their full scope of equivalents.

What is claimed is:

1. A method for analyzing test data for a computer application for processing groups of digital data having digital content units, comprising:
extracting the digital content units from a group of digital data;
assigning substitute IDs to the extracted digital content units; and
determining statistical characteristics of the substitute IDs to determine statistical characteristics of the group of digital data.

2. The method of claim 1, further comprising developing a visual representation of the statistical characteristics of the group of digital data, the visual representation having at least a first parameter and a second parameter, the second parameter being different from the first parameter.

3. The method in claim 2, wherein developing the visual representation further comprises:
retrieving the statistical characteristics of the group of digital data that correspond to the first parameter and to the second parameter; and
plotting the statistical characteristics of the group of digital data by the first and the second parameters.

4. The method in claim 1, wherein determining statistical characteristics further comprises calculating low, mean, and high values of frequency of occurrences of the substitute IDs corresponding to the extracted digital content units.

5. The method in claim 1,
wherein the extracted digital content units have at least one type; and
wherein assigning the substitute IDs to the extracted digital content units comprises:
developing a record for a selected extracted digital content unit;
generating a substitute ID for the selected extracted digital content unit;
associating the substitute ID with the record for the selected extracted digital content unit; and
prefixing the substitute ID with a signature identifying a type associated with the selected extracted digital content unit.

6. The method in claim 5, wherein assigning the substitute IDs further comprises:
checking a collection of records that has been developed for the extracted digital content units for the existence of the selected extracted digital content unit;
if the selected extracted digital content unit does not already exist in the collection, assigning the substitute ID to the selected extracted digital content unit and initiating a count of occurrences of the selected extracted digital content unit; and
if the selected extracted digital content unit already exists in the collection, extracting the substitute ID associated therewith and incrementing the count of the occurrences of the selected extracted digital content unit.

7. The method in claim 6, further comprising:
storing the record, the substitute ID associated with the selected extracted digital content unit for which the record was developed, and the count of occurrences of the selected extracted digital content unit, in a storage system; and
deleting the record from the storage system when assigning the substitute IDs to the extracted digital content units has been completed for the group of digital data.

8. The method in claim 1,
wherein the extracted digital content units have at least one type; and
wherein at least one of the extracted digital content units comprises a word or a phrase, the phrase having more than one word.

9. The method of claim 1,
wherein at least one of the digital content units has numerical content; and
wherein assigning the substitute IDs further comprises converting the numerical content into non-numerical content.

10. A system for analyzing test data for a computer application that is processing groups of digital data having digital content units, comprising:
a data store;
a data extractor for extracting the digital content units from a group of digital data;
an ID assigning unit for assigning substitute IDs to the extracted digital content units; and
a statistical unit for determining statistical characteristics of the substitute IDs to determine statistical characteristics of the group of digital data.

11. The system of claim 10, further comprising a graphics generator for developing a visual representation of the statistical characteristics of the group of digital data, the visual representation having at least a first parameter and a second parameter, the second parameter being different from the first parameter.

12. The system of claim 11, wherein the graphics generator further comprises:
a data retriever for retrieving the statistical characteristics of the group of digital data that corresponds to the first parameter and to the second parameter; and
a plotter for plotting the statistical characteristics of the group of digital data by the first and the second parameters.

13. The system of claim 10, wherein the statistical developer further comprises a calculator for determining the low, mean, and high values of frequency of occurrences of the substitute IDs corresponding to the extracted digital content units.

14. The system of claim 10,
wherein the extracted digital content units have at least one type; and
wherein the ID assigning unit further comprises:
a record developer for developing a record for a selected extracted digital content unit;
an ID generator for generating a substitute ID for the selected extracted digital content unit;
an association unit for associating the substitute ID with the record; and
a prefixing unit for prefixing the substitute ID with a signature identifying a type associated with the selected extracted digital content unit.

15. The system of claim 14, wherein the ID assigning unit further comprises:
a record review subsystem for checking a collection of records developed for the extracted digital content units for the existence of the selected extracted digital content unit; and
a digital content unit management subsystem for,
if the selected extracted digital content unit does not already exist in the collection, assigning the substitute ID to the selected extracted digital content unit and initiating a count of occurrences of the selected extracted digital content unit; and
if the selected extracted digital content unit already exists in the collection, extracting the substitute ID associated therewith and incrementing the count of the occurrences of the selected extracted digital content unit.

16. The system of claim 15, further comprising:
a storage system for storing the record, the substitute ID associated with the selected extracted digital content unit for which the record was developed, and the count of occurrences of the selected extracted digital content unit; and
a record deletion unit for deleting the record from the data storage system when assigning the substitute IDs to the extracted digital content units has been completed for the group of digital data.

17. The system of claim 10,
wherein the extracted digital content units have at least one type; and
wherein at least one of the extracted digital content units comprises a word or a phrase, the phrase having more than one word.

18. The system of claim 10,
wherein at least one of the digital content units has numerical content; and
wherein the ID assigning unit further comprises a content converter for converting the numerical content into non-numerical content.

19. A tangibly-embodied computer-readable storage medium comprising instructions to configure a computer to execute a method for analyzing test data for a computer application for processing groups of digital data having digital content units, the method comprising:
extracting the digital content units from a group of digital data;
assigning substitute IDs to the extracted digital content units; and
determining statistical characteristics of the substitute IDs to determine statistical characteristics of the group of digital data.

20. The medium of claim 19, wherein the method further comprises developing a visual representation of the statistical characteristics of the group of digital data, the visual representation having at least a first parameter and a second parameter, the second parameter being different from the first parameter.

21. The tangibly-embodied computer-readable medium of claim 19:
wherein the extracted digital content units have at least one type; and
wherein assigning the substitute IDs to the extracted digital content units comprises:
developing a record for a selected extracted digital content unit;
generating a substitute ID for the selected extracted digital content unit;
associating the substitute ID with the record for the selected extracted digital content unit; and
prefixing the substitute ID with a signature for identifying a type associated with the selected extracted digital content unit.

22. The medium of claim 21, wherein the method further comprises:
storing the record, the substitute ID associated with the selected extracted digital content unit for which the record was developed, and a count of occurrences of the selected extracted digital content unit, in a storage system; and
deleting the record from the storage system when assigning the substitute IDs to the extracted digital content units has been completed for the group of digital data.
